(19) United States
(12) Patent Application Publication
(10) Pub. No.: US 2005/0110196 A1
(43) Pub. Date: May 26, 2005

(54) Light guide plate injection mold

(75) Inventors: Tai-Cherng Yu, Tu-Cheng (TW); Charles Leu, Fremont, CA (US); Ga-Lane Chen, Fremont, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 10/971,515

(22) Filed: Oct. 22, 2004

(30) Foreign Application Priority Data
Nov. 21, 2003 (TW) 92132701

(51) Int. Cl. B29C 45/32; B29C 45/00

(52) U.S. Cl. 264/328.1; 425/572

(57) ABSTRACT

An injection mold (120) includes a stationary mold (121), a movable mold (122), and a core. The movable mold defines a cavity (126). The core is disposed in the cavity of the movable mold opposite from the stationary mold. The stationary mold includes a curved runner (125), and a flared gate (123) having an opening at least half the size of an opening of the cavity. With the combined runner and gate structure, movement of molten resin is slowed, and different portions of the cavity are filled up with molten resin virtually simultaneously. Accordingly, different portions of the molten resin are cooled at the same time, so that the light guide plate has an even density and low stress concentration. The light guide plate can then provide highly uniform brightness.

### BACKGROUND OF THE INVENTION

1. Field of the Invention

The present invention relates to injection molds, and particularly to an injection mold for forming light guide plates.

2. Description of the Prior Art

Nowadays, methods for manufacturing a light guide plate are classified into two types: printing methods and non-printing methods. A light guide plate injecting system is generally used in manufacturing a light guide plate by way of a non-printing method.

Referring to FIG. 3, a conventional light guide plate injecting system 18 generally includes an injection mold 10 and an injection molding machine 30. The injection mold 10 comprises a stationary mold 16, a movable mold 17, and a core 13. The movable mold 17 defines a cavity 19. The core 13 has a plurality of dots disposed thereon in a predetermined array, and is received in the cavity 19 of the movable mold 17 opposite from the stationary mold 16. The stationary mold 16 has a runner 12 and a gate 14 therein, through which molten resin is injected into the cavity 19 to form a light guide plate. The injection molding machine 30 includes a feeding hopper 31, a barrel 33, and a motor 32.

In operation, feedstock is provided through the feeding hopper 31 into the barrel 33. The feedstock is melted into molten resin by the application of heat and pressure. The molten resin is injected into the cavity 19 via the runner 12 and the gate 14 under force provided by the motor 32. Injection of molten resin continues until the cavity 19 is completed filled. The molten resin is cooled, and the light guide plate is removed from the injection mold 10.

In the light guide plate injecting system 18, the runner 12 is substantially a straight tube. The gate 14 flares from the runner 12 to the cavity 19. However, a cross-sectional area of the gate 14 at the cavity 19 is far less than a corresponding cross-sectional area of the cavity 19. This configuration of the runner 12 and the gate 14 results in the molten resin being rapidly propelled into the cavity 19, with different portions of the cavity 19 being filled up at different times. Accordingly, when cooling, the light guide plate develops an uneven density and stress concentration. The light guide plate is liable to warp in the cooling process, and subsequently deliver impaired optical performance in use.

A new mold for manufacturing a light guide plate which overcomes the above-mentioned disadvantages is desired.

### SUMMARY OF THE INVENTION

An object of the present invention is to provide an injection mold which produces a light guide plate having an even density and low stress concentration.

In order to achieve the object set out above, there is provided an injection mold comprising a stationary mold, a movable mold, and a core. The movable mold defines a cavity. The core is disposed in the cavity of the movable mold opposite from the stationary mold. The stationary mold comprises a curved runner, and a flared gate having an opening at least half the size of an opening of the cavity. With the combined runner and gate structure, movement of molten resin is slowed, and different portions of the cavity are filled up with molten resin virtually simultaneously. Accordingly, different portions of the molten resin are cooled at the same time, so that the light guide plate attains an even density and low stress concentration. The light guide plate can then provide highly uniform brightness in use.

Other objects, advantages, and novel features of the present invention will be apparent from the following detailed description of preferred embodiments thereof with reference to the attached drawings.

### BRIEF DESCRIPTION OF THE DRAWINGS

FIG. 1 is a schematic, cross-sectional view of a light guide plate injecting system having an injection mold according to a preferred embodiment of the present invention.

FIG. 2 is an exploded, schematic view of boundaries of a cavity, a funnel-shaped gate, and an S-shaped runner of the injection mold of FIG. 1.

FIG. 3 is a schematic, cross-sectional view of a prior art light guide plate injecting system having a conventional injection mold.

### DETAILED DESCRIPTION OF THE PRESENT INVENTION

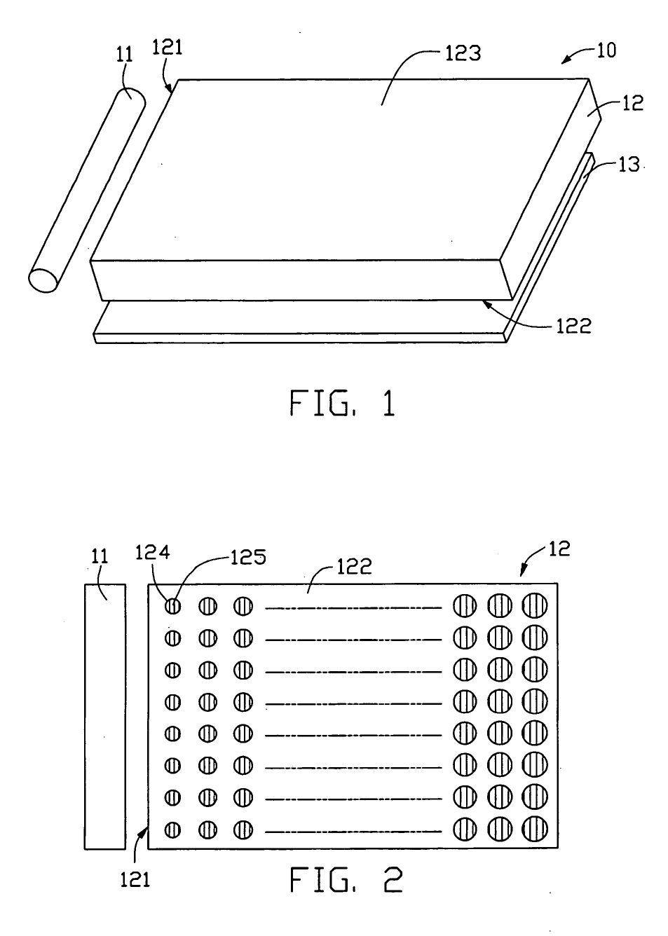

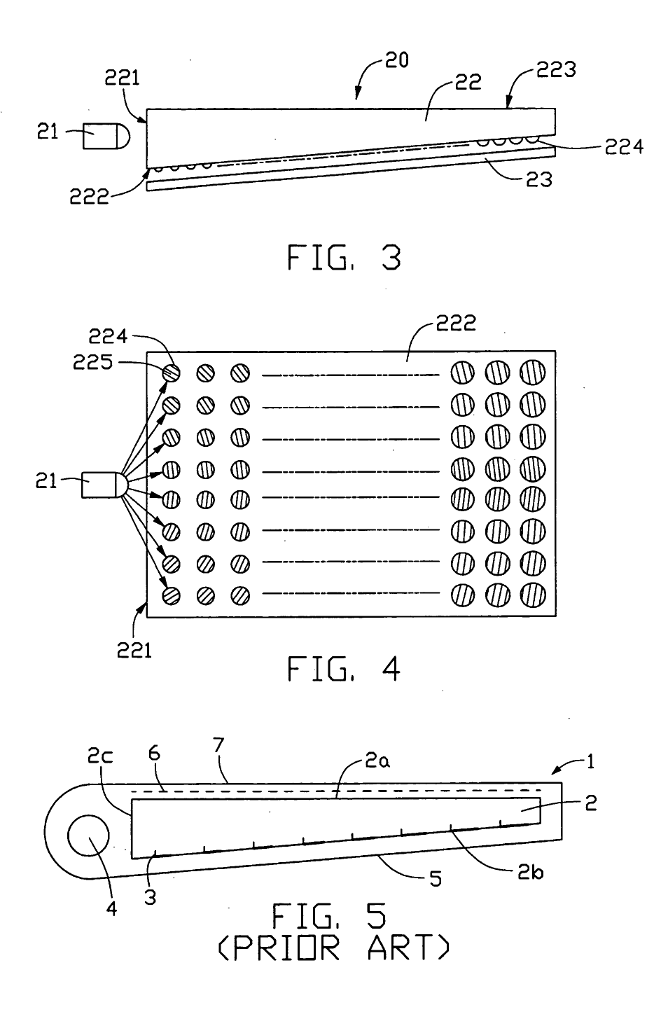

Referring to FIG. 1 and FIG. 2, a light guide plate injecting system 28 comprises an injection mold 120 according to the preferred embodiment of the present invention, and an injection molding machine 100. The injection mold 120 comprises a stationary mold 121, and a movable mold 122 opposite to the stationary mold 121. The injection mold 120 is made of a high thermally conductive metal such as a copper alloy or a nickel cobalt alloy.

The movable mold 122 has a cavity 126 opposite to the stationary mold 121, and a core (not shown) disposed on a bottom surface 1262 bounding the cavity 126. The cavity 126 defines a rectangular top boundary 1266, which has a width EH (or FG) and a length EF (or HG). The core has a plurality of dots provided thereon in a predetermined array, in order to form a corresponding pattern on a molded light guide plate. The array of dots can be formed by a laser manufacturing method or by an electro forming method.

The stationary mold 121 comprises an S-shaped runner 125 and a funnel-shaped gate 123. The funnel-shaped gate 123 defines a rectangular bottom boundary 1232, and is bounded by a buffer member 127 of a sidewall (not labeled). In the illustrated embodiment, the buffer member 127 is a plurality of V-shaped protrusions. In an alternative embodiment, the buffer member 127 can, for example, be a plurality of semicylindrical protrusions. The bottom boundary 1232 has a width AD (or BC) and a length AB (or DC). The width AD of the bottom boundary 1232 of the stationary mold 121 is greater than half of the width EH of the top boundary 1266. The length AB of the bottom boundary 1232 is less than the length EF of the top boundary 1266, and preferably the length AB is 0.2 mm less than the length EF.

The injection molding machine 100 includes a feeding hopper 104, a barrel 101, a screw 102, a band heater 105, and a motor 103.

In assembly, the stationary mold 121 and the movable mold 122 are combined together, with the funnel-shaped gate 123 facing the cavity 126. Molten resin can then be injected into the cavity 126 through the funnel-shaped gate 123.

In operation, feedstock is provided through the feeding hopper 104 into the barrel 101. The feedstock is melted into molten resin by the band heater 105. The motor 103 drives the screw 102 to propel the molten resin into the injection mold 120. The molten resin is injected into the cavity 126 through the S-shaped runner 125 and the funnel-shaped gate 123. Injection of molten resin continues until the cavity 126 is completely filled. The molten resin is cooled, and the light guide plate is removed from the injection mold 120.

The S-shaped runner 125 and the buffer member 127 function to change and diversify the directions of movement of the molten resin, and thus keep the molten resin flowing into the cavity 126 at a uniform speed. The funnel-shaped gate 123 progressively widens from the S-shaped runner 125 to the bottom boundary 1232. This progressively decreases the speed of the molten resin, and helps ensure that different portions of the cavity are filled up virtually simultaneously. Accordingly, different portions of the molten resin in the cavity are cooled at the same time, so that the light guide plate attains an even density and low stress concentration. The light guide plate can then provide highly uniform brightness in use.

It is to be understood that the S-shaped runner 125 is not limited to being S-shaped. In alternative embodiments, the S-shaped runner 125 can have other shapes which fulfill the above-described function. Further, in the illustrated embodiment, the funnel-shaped gate 123 is substantially frusto-pyramidal shaped. In alterative embodiments, the funnel-shaped gate 123 can have other shapes which fulfill the above-described function. For example, the funnel-shaped gate 123 can be substantially wedge-shaped.

It is to be further understood that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An injection mold comprising:
a stationary mold;
a movable mold adjacent the stationary mold and defining a cavity; and
a core disposed in the movable mold opposite to the stationary mold;
wherein the stationary mold comprises a curved runner, and a flared gate having an opening at least half the size of an opening of the cavity.

2. The injection mold as claimed in claim 1, wherein the runner is S-shaped, and the gate is funnel-shaped.

3. The injection mold as claimed in claim 2, wherein a width of a boundary of the funnel-shaped gate adjacent the cavity is greater than half a corresponding width of a boundary of the cavity adjacent the funnel-shaped gate.

4. The injection mold as claimed in claim 2, wherein a length of a boundary of the funnel-shaped gate adjacent the cavity is less than a corresponding length of the boundary of the cavity adjacent the funnel-shaped gate.

5. The injection mold as claimed in claim 4, wherein the length of said boundary of the funnel-shaped gate is 0.2 mm less than the length of said boundary of the cavity.

6. The injection mold as claimed in claim 4, wherein the funnel-shaped gate has a buffer member disposed thereat.

7. The injection mold as claimed in claim 6, wherein the buffer member comprises a plurality of V-shaped protrusions.

8. The injection mold as claimed in claim 6, wherein the buffer member comprises a plurality of semicylindrical protrusions.

9. The injection mold as claimed in claim 4, wherein the injection mold comprises a copper alloy.

10. The injection mold as claimed in claim 4, wherein the injection mold comprises a nickel cobalt alloy.

11. An injection system comprising:
a machine for providing feedstock;
a stationary mold part disposed adjacent to said machine to provide a feedstock-passing path therethrough, said path adapted to be feedstock-drawable to substantially change an injection direction of said feedstock; and
a movable mold part disposed next to said stationary mold part and defining a cavity between said stationary and movable mold parts in communication with said path to accumulate said injected feedstock.

12. The injection system as claimed in claim 11, wherein said path is formed partially by a non-linear runner.

13. The injection system as claimed in claim 11, wherein said path is formed partially by a gate having at least one feedstock-drawable buffer member formed along a sidewall of said gate.

14. The injection system as claimed in claim 13, wherein said gate is widen in apart thereof close to sand in communication with said cavity.

15. A method for injection, comprising:
providing workable feedstock;
providing a cavity to receive said feedstock as a destination of said injection; and
moving said feedstock toward said cavity by at least one direction-changing way to allow said feedstock movable to said cavity along at least two different directions.

16. The method as claimed in claim 15, wherein said at least one direction-changing way is moving said feedstock along an S-shaped runner.

17. The method as claimed in claim 15, wherein said at least one direction-changing way is moving said feedstock across a plurality of protrusions.
